(19) United States
(12) Patent Application Publication
(10) Pub. No.: US 2018/0046225 A1
(43) Pub. Date: Feb. 15, 2018

(54) THREE-PART COMPUTING DEVICE

(71) Applicant: GOOGLE INC., Mountain View, CA (US)

(72) Inventors: Omri AMARILIO, Palo Alto, CA (US); Katie Leah ROBERTS-HOFFMAN, San Jose, CA (US)

(21) Appl. No.: 15/237,277

(22) Filed: Aug. 15, 2016

(51) Int. Cl. G06F 1/16; G06F 3/041

(52) U.S. Cl. CPC G06F 1/1669; G06F 1/1616; G06F 1/1681; G06F 1/1601; G06F 3/0412; G06F 3/0416

(57) ABSTRACT

A three-part computing device includes a display portion, a base portion, and a keyboard portion. The display portion can include a touchscreen, and the keyboard portion can include a keyboard having a plurality of keys. The base portion can include a central processing unit, memory, and a battery. The display portion, the base portion, and the keyboard portion are mechanically coupled to a common connector. The display portion can be pivotably rotatable about a longitudinal axis of the common connector with respect to the base portion and the keyboard portion. The keyboard portion is detachably coupled to the common connector and can be detached from the common connector while the display portion and the base portion remain coupled to the common connector.

### TECHNICAL FIELD

The following disclosure relates to the technical field of portable computing devices.

### BACKGROUND

A conventional portable computing device, such as a laptop computer or notebook computer can include a lid and a base. The lid can include a display (e.g., a LED, LCD, or touchscreen display) and the base can include one or more input devices such as a keyboard, a trackpad, a touchpad, or a fingerprint reader, for example. The base can also include one or more processors, memory, a power source, and other components that provide computing functionality. Generally, the lid and the base of the portable computing device are attached such that the lid can be moved and/or rotated with respect to the base and placed in several configurations. For example, in a closed configuration, the bottom of the lid can be in contact with the top of the base with the lid and the base rotated to an approximate 0-degree position with respect to each other. In such a closed configuration, the display on the bottom of lid may contact, or be in close proximity to, the input devices on the top of the base.

Some portable computing devices utilize touchscreen displays which can be used by users to provide input to the portable computing device. Such portable computing devices may be operable in two different modes—a conventional laptop mode and a tablet mode—and may be referred to as convertible computing devices. In the laptop mode, a user may provide input to the portable computing device via a keyboard or other input device disposed on the base of the portable computing device, and the lid may be rotated with respect to the base at an angle (e.g., a 130-degree angle) such that the user can view the display on the lid while providing input via the input devices located on the base. In the tablet mode, the lid may be rotated around a longitudinal axis of a hinge of the portable computing device by approximately 360 degrees with respect to the base so that the touchscreen display is on one side of the convertible computing device, leaving the input devices on the top of the base exposed on the other side the of the convertible computing device.

When in tablet mode, a convertible computing device may disable the input devices so users do not inadvertently provide input to the convertible computing device. As a result, the input devices are not needed while the convertible computing device is in tablet mode. Accordingly, some portable computing devices—often referred to as detachable computing devices—allow users to detach the base and its input devices from the lid (and therefore the computing device) when operating in tablet mode. But, in such devices, the one or more processors, memory, power source, and other components that provide computing functionality may be disposed in the lid portion of the detachable computing device so that the display has the necessary hardware to provide computing functionality when the base has been detached. As a result, the lid (housing the display) can be quite heavy relative to the base causing instability when operating the detachable in laptop mode. Stability may be addressed by adding an additional support to the lid, or moving the attachment point between the lid and the base away from the back edge of the base toward the middle of the base. But, such solutions are generally effective in situations where the detachable computing device is used on rigid and/or even surfaces, such as table or desk. Instability remains when a detachable computing device is used on a non-rigid or uneven surface, such as a user's lap, because the computing components in the lid cause the device to be top-heavy.

### SUMMARY

In one aspect, a portable computing device includes a display portion, a base portion, and a keyboard portion. The display portion can include a touchscreen, and the keyboard portion can include a keyboard having a plurality of keys. The base portion can include a central processing unit, memory, and a battery. The display portion, the base portion, and the keyboard portion are mechanically coupled to a common connector. The display portion can be pivotably rotatable about a longitudinal axis of the common connector with respect to the base portion and the keyboard portion. The keyboard portion is detachably coupled to the common connector and can be detached from the common connector while the display portion and the base portion remain coupled to the common connector.

Various implementations of this aspect may include one or more of the following features. In some implementations, the display portion can be pivotably rotatable through more than 180 degrees about the longitudinal axis of the common connector with respect to the base portion or the keyboard portion. In some implementations, the keyboard portion can be pivotably rotatable through more than 180 degrees about the longitudinal axis of the common connector with respect to the base portion or the display portion. In some implementations, the base portion can be pivotably rotatable through more than 180 degrees about the longitudinal axis of the common connector with respect to the keyboard portion or the display portion. The common connector can include a hinge, and in some implementations, the display portion comprises a first barrel hinge, the base portion comprises a second barrel hinge, the keyboard portion comprises a third barrel hinge, and the common connector comprises a fourth barrel hinge. In some implementations, the common connector includes a cavity through which a wire passes power from the base portion to the display portion. The base portion can include a power supply in some embodiments.

In another aspect, a computing device includes a first housing, a second housing, and a third housing. The first housing can include a touchscreen display, the second housing can include a processor, memory and a battery, and the third housing can include a keyboard disposed on a face of the third housing. The computing device can also include a common connector mechanically connecting the first housing, the second housing, and the third housing such that the first housing, the second housing and the third housing are rotatable about a longitudinal axis of the common connector. The third housing can connect to the common connector at one of its long edges and the third housing can be detachably coupled to the common connector, such that the third housing is detachable from the common connector while the first housing and the second housing remain coupled to the common connector.

Various implementations of this aspect may include one or more of the following features. In some implementations, the first housing, the second housing, and the third housing can be separate housings. The first housing can be pivotably rotatable through more than 180 degrees about the longitudinal axis of the common connector with respect to the second housing or the third housing, the second housing can be pivotably rotatable through more than 180 degrees about the longitudinal axis of the common connector with respect to the first housing or the third housing, and the third housing can be pivotably rotatable through more than 180 degrees about the longitudinal axis of the common connector with respect to the first housing or the second housing, in various implementations. In some implementations, the common connector can include a hinge. In some implementations, the first housing comprises a first barrel hinge, the second housing comprises a second barrel hinge, the third housing comprises a third barrel hinge, and the hinge of the common connector can be a barrel hinge. In some implementations, a face of the first housing can be capable of touching a face of the second housing by rotating either the first housing or the second housing about the longitudinal axis of the common connector. The common connector can include a cavity through which a wire passes power from the second housing to the first housing, according to some implementations.

In another aspect, a method for providing a computing device includes providing a display housing comprising a touchscreen, providing a base housing comprising a processor, a memory, and a battery disposed within the base housing, and providing a keyboard housing. The method can also include detachably connecting the display housing, the base housing, and the keyboard housing to a common connector such that the display housing, the base housing, and the keyboard housing are rotatable about a longitudinal axis of the common connector. The keyboard housing may be detachably coupled to the common connector such that the keyboard housing is detachable from the common connector while the display housing and the base housing remain coupled to the common connector.

In some implementations of this aspect, the common connector can include a first barrel hinge, the display housing can include a first barrel hinge, the base housing can include a second barrel hinge, the keyboard housing can include a third barrel hinge, and the common connector can include a fourth barrel hinge. In this aspect, the common connect may include a cavity through which a wire passes power from the base housing to the display housing, according to some implementations.

The details of one or more implementations are set forth in the accompanying drawings and the description below. Other features will be apparent from the description and drawings, and from the claims.

### BRIEF DESCRIPTION OF THE DRAWINGS

FIG. 1A shows a side view of a three-part computing device consistent with disclosed embodiments.

FIG. 1B shows a perspective view of a three-part computing device consistent with disclosed embodiments.

FIG. 2A shows a side view of a three-part computing device in a laptop configuration consistent with disclosed embodiments.

FIG. 2B shows a side view of a three-part computing device in a pre-tablet configuration consistent with disclosed embodiments.

FIG. 2C shows a side view of a three-part computing device in a tablet configuration consistent with disclosed embodiments.

FIG. 2D shows a side view of a three-part computing device in a kiosk configuration consistent with disclosed embodiments.

FIG. 2E shows a side view of a three-part computing device in a closed configuration consistent with disclosed embodiments.

FIG. 3 shows an embodiment of a three-part computing device consistent with disclosed embodiments.

FIG. 4 shows a bottom view of a common connector consistent with disclosed embodiments.

FIG. 5 shows a side view of a common connector consistent with disclosed embodiments.

FIG. 6 shows another embodiment of a three-part computing device consistent with disclosed embodiments.

FIG. 7 shows another embodiment of a three-part computing device consistent with disclosed embodiments.

FIG. 8 shows a block diagram for a three-part computing device consistent with disclosed embodiments.

FIG. 9 shows a flowchart for a three-part computing device providing process consistent with disclosed embodiments.

### DETAILED DESCRIPTION

The embodiments disclosed herein address problems of convertible and detachable computing devices by splitting a portable computing device into three portions as opposed to two. The three-part computing device includes a display portion or housing, a base portion or housing, and a keyboard portion or housing. In some embodiments, the display portion houses a touchscreen or other display, the base portion houses general purpose computing components such as a processor, a memory, and a power source (e.g., a power supply and/or battery), and the keyboard portion houses one or more input devices, such as a keyboard and/or touchpad. The base portion can couple with either the display portion or the keyboard portion to provide adequate counter weight in a laptop configuration, and to provide computer functionality to the display in a tablet configuration. For example, the three portions can be attached to a common connector that allows them to rotate around a longitudinal axis of the three-part computing device so that when the three-part computing device is in a laptop configuration, sufficient counterweight is supplied to the display to provide stability. Furthermore, while in the tablet configuration, the keyboard portion can be detached.

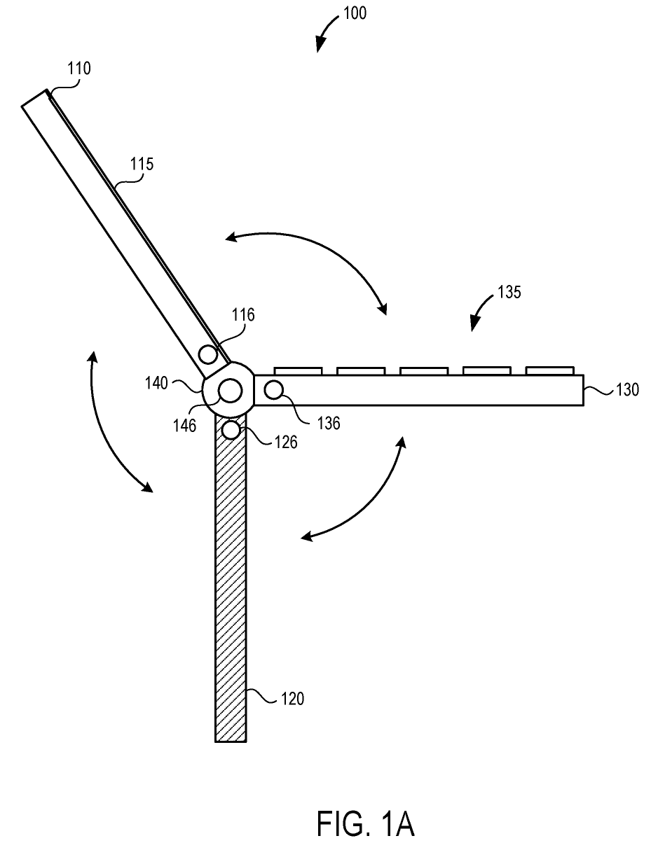

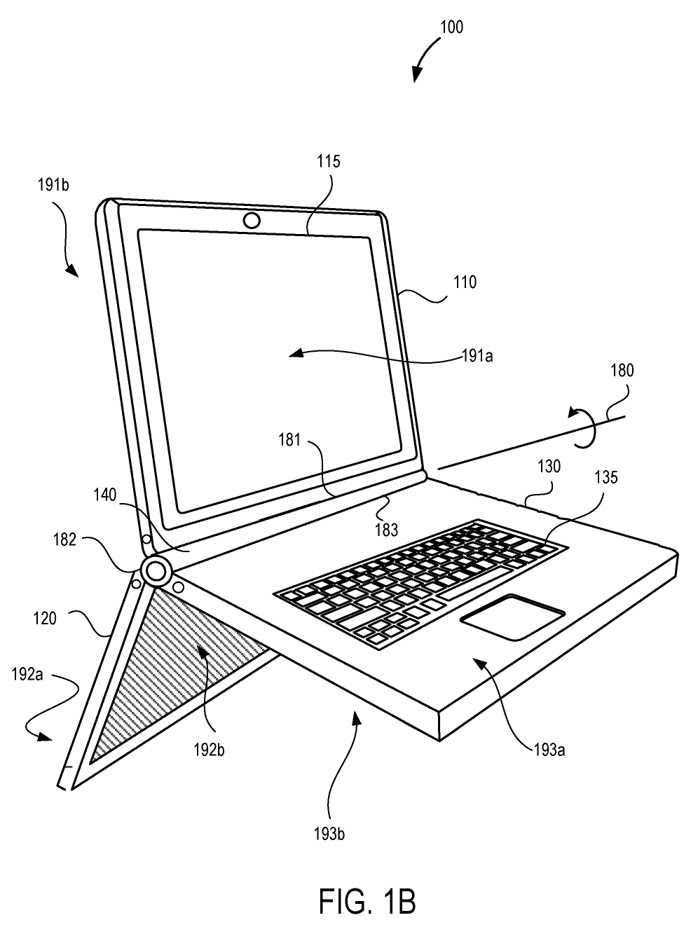

FIG. 1A shows a side view of a three-part computing device 100. In some embodiments three-part computing device 100 includes display housing 110, base housing 120, and keyboard housing 130. As shown in FIG. 1A, display housing 110, base housing 120, and keyboard housing 130 may be connected to common connector 140 along a long inner edge of each housing. As used herein, display housing 110 may be referred to as a display portion, a display component, or the like. Similarly, base housing 120 may be referred to as a base portion, a base component or the like, and keyboard housing 130 may be referred to as a keyboard portion, a keyboard component, or the like.

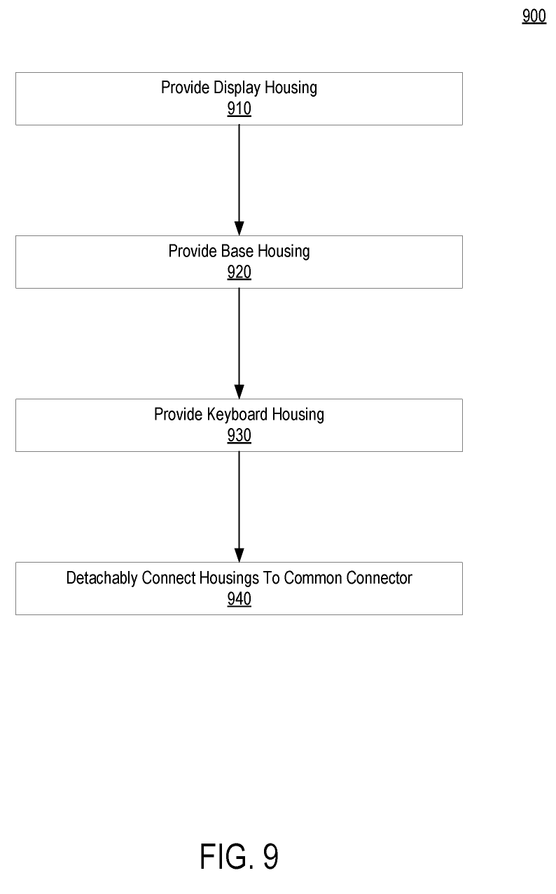

In some embodiments, display housing 110 includes touchscreen 115. Touchscreen 115 can be any display screen capable of detecting touch input events on its surface. For example, touchscreen 115 may be a capacitive touchscreen that detects a change in capacitance at a location on touchscreen 115 when a user touches touchscreen 115 at that location. Touchscreen 115 can also be a resistive touchscreen in some embodiments. In some embodiments, touchscreen 115 can be connected to a processor located within base housing 120 and touchscreen 115 may send signals corresponding to touch events to the processor within base housing 120. Likewise, the processor within base housing 120 may send electronic signals to touchscreen 115 that touchscreen 115 can interpret for rendering graphics. In some embodiments, and as described in more detail with respect to FIG. 9 below, display housing 110 can also include a graphics processor and a display and control interface that can be used to process touch input events and/or can be used for interpreting signals sent from the processor within base housing 120 to render graphics.

According to some embodiments base housing 120 can include general-purpose computing components that perform functions and operations consistent with a computing device, such as a laptop or tablet. For example, base housing 120 can include a CPU or processor, a memory, buses, communication circuits (e.g., Ethernet adapters, Wi-Fi modules, cellular network modulators, Bluetooth modules), buses, and one or more power sources such as a battery or a power source that can convert AC to DC. In some embodiments, base housing 120 can also include components for receiving and producing audio such as microphones and speakers. Base housing 120 can also include one or more ports for connecting three-part computing device 100 to peripheral devices. The one or more ports can include for example, USB ports, serial ports, parallel ports, FireWire ports, or any other ports capable of providing input to or receiving output from peripheral devices.

Three-part computing device 100 can also include keyboard housing 130. Keyboard housing 130, in some embodiments, may include keyboard 135 disposed on a face of keyboard housing 130. Keyboard 135 can include a plurality of keys, such as ASCII character keys, numeric keys, function keys, and control keys that can be used by a user of three-part computing device 100 to provide input to three-part computing device 100. Keyboard housing 130 may also include other components for providing input to three-part computing device 100. For example, keyboard housing 130 can include a trackpad, touchpad, pointing stick, fingerprint reader, retinal scanner, microphone, and the like.

Three-part computing device 100 can also include common connector 140. Common connector 140 may be disposed at the center of three-part computing device 100 and may connect to display housing 110, base housing 120, and keyboard housing 130 along their long inner edges. In some embodiments, common connector 140 can include pivot point 146. Pivot point 146 can include, in some embodiments, a pin or a barrel for a hinge of common connector 140. For example, pivot point 146 can be cylindrical and allow for 180-degrees of rotation of one of display housing 110, base housing 120, or keyboard housing 130 around a longitudinal axis of common connector 140. In some embodiments, pivot point 146 includes a friction element that provides some resistance and/or support to display housing 110, base housing 120, and keyboard housing 130. In some elements, pivot point can be a barrel hinge.

In some embodiments, display housing 110, base housing 120, and keyboard housing 130 each include a pivot point (116, 126, 136 respectfully). Pivot points 116, 126, 136 can include, in some embodiments, a pin or a barrel for a hinge of their respective housings. For example, pivot points 116, 126, 136 can be cylindrical and allow for 180-degrees of rotation of display housing 110, base housing 120, or keyboard housing 130 with respect to each other. In some embodiments, pivot points 116, 126, 136 can include a friction elements that provides some resistance and/or support to display housing 110, base housing 120, and keyboard housing 130. In some elements, pivot points 116, 126, 136 can be barrel hinges.

According to some embodiments, pivot point 146 can form a dual pivot hinge with the pivot points disposed within display housing 110, base housing 120, or keyboard housing 130 allowing for approximately 360 degrees of rotation for each of display housing 110, base housing 120, or keyboard housing 130 with respect to each other. For example, pivot point 146 can form a dual pivot hinge with pivot point 116 of display housing 110, and as pivot point 146 and pivot point 116 each provide approximately 180 degrees of rotation, together they enable display housing 110 to rotate approximately 360 degrees from either base housing 120 or keyboard housing 130. Similarly, pivot point 146 can form a dual pivot hinge with pivot point 126 of base housing 120, and as pivot point 146 and pivot point 116 each provide for approximately 180 degrees of rotation, together they enable base housing 120 to rotate approximately 360 degrees from either display housing 110 or keyboard housing 130. Likewise, pivot point 146 can form a dual pivot hinge with pivot point 136 of keyboard housing 130, and as pivot point 146 and pivot point 136 each provide approximately 180 degrees of rotation, together they enable keyboard housing 130 to rotate approximately 360 degrees from either base housing 120 or display housing 110.

In some embodiments, common connector 140 can also include a cavity in which a conductive element is disposed. The conductive element can include a wire or a plurality of wires to transfer power and/or data from base housing 120 to display housing 110 and keyboard housing 130. For example, the conductive element within common connector 140 may send electrical signals from the processor of base housing to touchscreen 115 of the display housing 110. The conductive element within common connector 140 may also send power from the power source within base housing 120 to touchscreen 115 of display housing 110. Keyboard housing 130 can also send input signals from keyboard 135 to the processor of base housing 120, as another example.

According to some embodiments, common connector 140 may have disposed on it one or more contacts that engage with contacts disposed on display housing 110, base housing 120, and keyboard housing 130. The one or more contacts of common connector 140 may be electrically connected to the conductive element disposed within the cavity of common connector 140. For example, common connector 140 may have 3 USB type-c micro plugs (or female connectors) and display housing 110, base housing 120, and keyboard housing 130 may each have a USB type-c micro jacks (or male connectors). When the type C micro jacks of display housing 110, base housing 120, and keyboard housing 130 engage with the type C micro plugs of common connector 140, power and data can be sent to and from each of display housing 110, base housing 120, and keyboard housing 130 via the conductive element disposed within the cavity of common connector 140.

FIG. 1B shows a perspective view of three-part computing device 100. As noted above, in some embodiments, display housing 110 can rotate approximately 360 degrees with respect to base housing 120 and keyboard housing 130 about longitudinal axis 180 of common connector 140. Similarly, base housing 120 can rotate approximately 360 degrees with respect to display housing 110 and keyboard housing 130 about longitudinal axis 180 of common connector 140. Likewise, keyboard housing 130 can rotate approximately 360 degrees with respect to display housing 110 and base housing 120. Such rotation may be enabled by the dual pivot hinges formed by pivot point 146 and pivot point 116 (for display housing 110), pivot point 146 and pivot point 126 (for base housing 120) and pivot point 146 and pivot point 136 (for keyboard housing 130).

As shown in FIG. 1B, display housing 110 can include long inner edge 181 that runs the length of common connector 140 and serves as an engaging surface for common connector 140. Similarly, base housing 120 can include long inner edge 182 that runs the length of common connector 140 and serves as an engaging surface for common connector 140. Likewise, keyboard housing 130 can include long inner edge 183 the runs the length of common connector 140 and serves as an engaging surface with common connector 140.

Display housing 110, base housing 120, and keyboard housing 130 can each include faces that will, in some configurations, of three-part computing device 100 touch and/or engage with each other as display housing 110, base housing 120, a keyboard housing 130 rotate about longitudinal axis 180. For example, display housing 110 can include face 191a (on which touchscreen 115 is disposed) and face 191b. Base housing 120 can include face 192a and face 192b and keyboard housing 130 can include face 193a (on which keyboard 135 is disposed) and 193b.

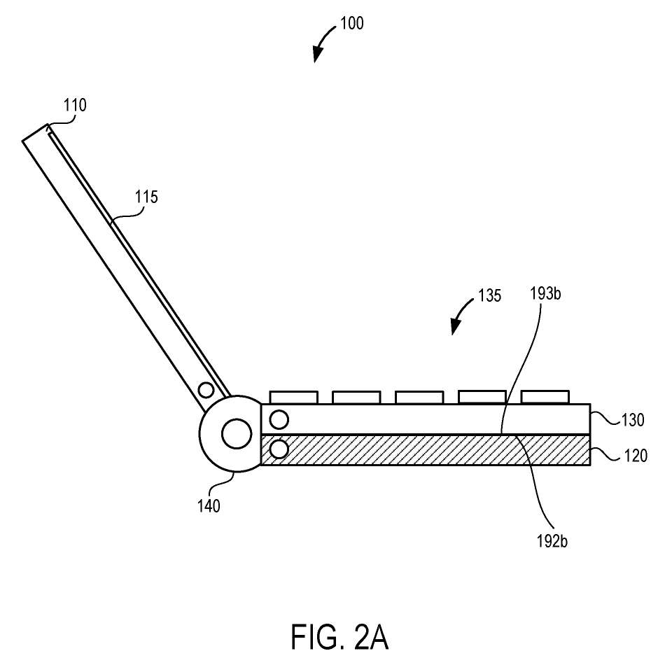

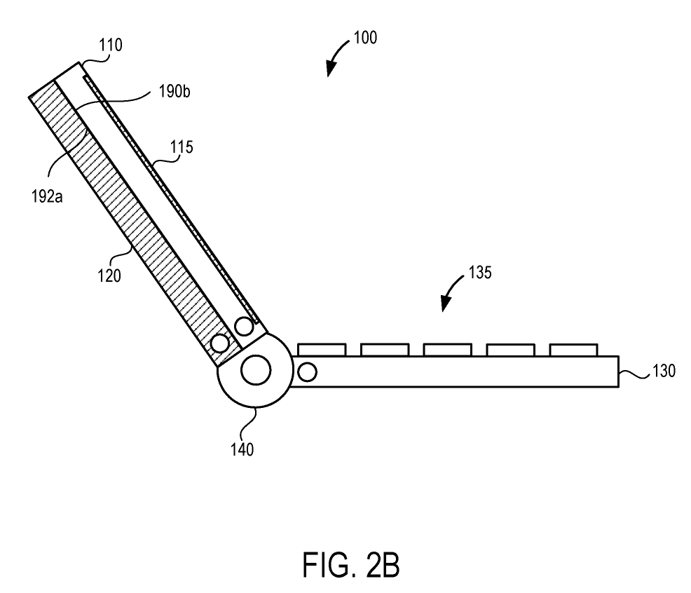

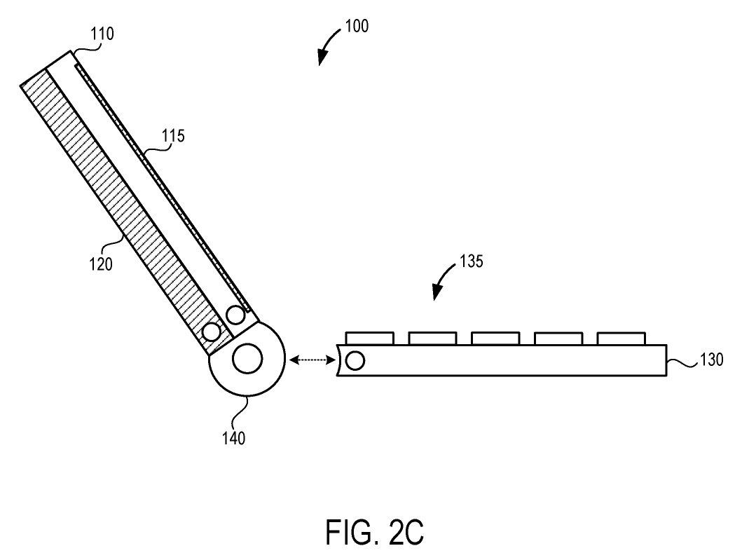

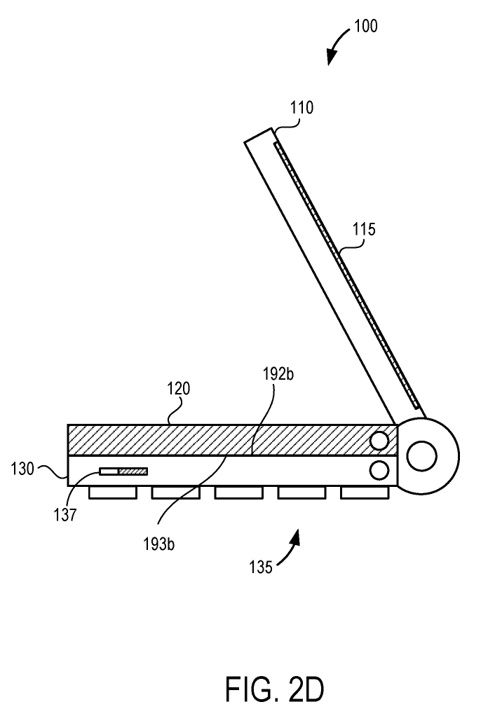

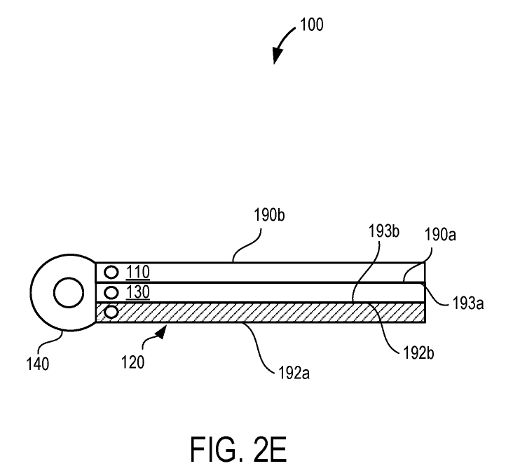

FIG. 2A shows a side view of three-part computing device 100 in a laptop configuration. In a laptop configuration, base housing 120 rotates about the longitudinal axis of common connector 140 and engages keyboard housing 130. According to one embodiment, face 192b of base housing 120 engages with a face 193b of keyboard housing 130 when three-part computing device 100 is in the laptop configuration. In the laptop configuration, base housing 120 and keyboard housing 130 provide counterweight to display housing 110 so that three-part computing device 100 can remain stable when on an uneven surface such as a user's lap. In the laptop configuration, display housing 110 may be rotated about the longitudinal access of common connector 140 so that touchscreen 115—rendering graphics for display to the user—can be visible to the user. For example, display housing 110 may be rotated to form an approximate 135 degree angle with keyboard housing 130.

FIG. 2B and FIG. 2C show three-part computing device 100 in configurations corresponding to use as a tablet computing device. According to some embodiments, keyboard housing 130 may be detached from common connector 140 (and by extension three-part computing device 100) when three-part computing device 100 is used as a tablet. FIG. 2B shows three-part computing device 100 in a pre-tablet configuration before keyboard housing 130 has been detached from common connector 140. In the pre-tablet configuration, base housing 120 has been rotated about the longitudinal axis of common connector 140 such that face 192a of base housing 120 engages with face 191b of display housing 110. According to some embodiments, in the pre-tablet configuration shown in FIG. 2B, three-part computing device 100 may be unstable and/or top-heavy. For example, keyboard housing 130 may be of insufficient weight to act as a counterbalance to the combination of display housing 110 and base housing 120.

FIG. 2C shows a side view of three-part computing device 100 and a tablet configuration where keyboard housing 130 has been detached from common connector 140. In the tablet configuration, base housing 120 remains mechanically coupled to display housing 110 via common connector 140, and base housing 120 may provide power and computing resources (such as a processor and memory) to display housing 110.

FIG. 2D shows a side view of three-part computing device 100 in a kiosk configuration. In some embodiments of the kiosk configuration, such as the one shown in FIG. 2D keyboard 135 may be resting on and touching a surface such as a table, desk, or counter, and keyboard 135 may be disabled by moving switch 137 to the off position. In other embodiments (e.g., those not shown in FIG. 2D), keyboard housing 130 may be removed and reattached such that when keyboard housing 130 rotates about the longitudinal axis of common connector 140, keyboard 135 is not exposed and instead engages with face 192b of base housing 120.

According to some embodiments, in the kiosk configuration, base housing 120 is rotated about the longitudinal axis of common connector 140 such that face 192b engages with face 193b of keyboard housing 130 (or face 193a of keyboard housing in some embodiments). In addition, display housing 110 may be rotated about the longitudinal axis of common connector 140 such that display housing 110 forms an acute angle with base housing 120 and display housing 110 forms an obtuse angle greater than 180 degrees with keyboard housing 130.

According to some embodiments, three-part computing device 100 can be placed in a closed configuration, which is shown in FIG. 2E. In the closed configuration, display housing 110 base housing 120 and keyboard housing 130 can be rotated about the longitudinal axis of common connector 140 such that each of the housings engage another forming an approximate 0 degree angle, touchscreen 115 on display housing 110 is concealed from view, and keyboard 135 of keyboard housing 130 is concealed from view. According to one embodiment, when three-part computing device 100 is in the closed configuration, display housing 110 engages with keyboard housing 130 and keyboard housing 130 engages with base housing 120 such that no face of keyboard housing 130 is exposed. In some embodiments, when three-part computing device 100 is in the closed configuration face 190a of display housing 110 engages with face 193a of keyboard housing 130 and face 193b of keyboard housing 130 engages with face 192b of base housing 120.

According to some embodiments, display housing 110, base housing 120, and keyboard housing 130 are mechanically coupled to common connector 140, and can each be detached in certain configurations. Three-part computing device 100 may employ one or more connection mechanisms so that display housing 110, base housing 120, and keyboard housing 130 can be selectively attached and detached from three-part computing device 100 at common connector 140. For example, display housing 110, base housing 120, and keyboard housing 130 may attach and detach to common connector 140 using a tongue and groove the system, a hook system, or a magnetic system, or similar connection mechanisms.

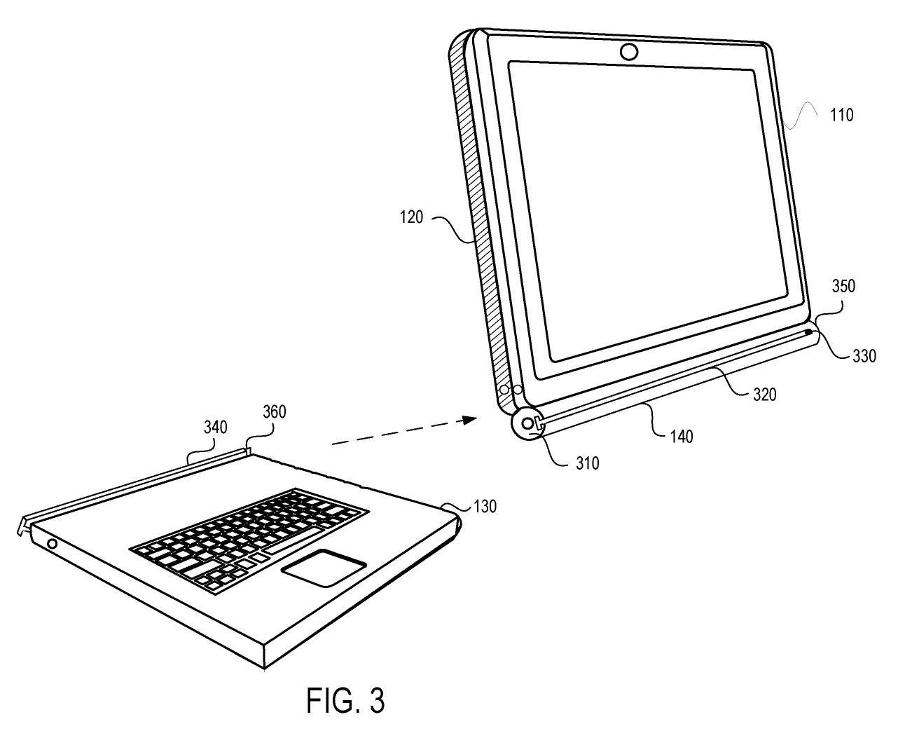

FIG. 3 shows one embodiment of three-part computer device 100 where display housing 110, base housing 120, and keyboard housing 130 attach to common connector 140 using a tongue and groove system. Although FIG. 3 shows a tongue and grove system with respect to keyboard housing 130, in some embodiments display housing 110 and base housing 120 may also connect to common connector 140 using a tongue and groove system. In embodiments using a tongue and groove system, common connector 140 may include bottom 310 and top 350. On bottom 310, groove 320 may be exposed so that common connector 140 can accept tongue 340 of keyboard housing 130. In some embodiments, groove 320 and tongue 340 form a pressure fit, and in some embodiments groove 320 may include a latch (not shown) that holds tongue 340 in place. To attach keyboard housing 130, a user may line up the notches of tongue 340 with the shape of groove 320 at bottom 310 and slide keyboard housing 130 toward top 350 until keyboard housing 130 is fully engaged with common connector 140. In some embodiments, groove 320 includes contact 330 which can be a jack or plug connected to conductive material (for example, a wire) disposed within a cavity of common connector 140. Likewise tongue 340 may include contact 360 which can be a plug or Jack that engages with contact 330 to transmit signals captured by keyboard housing 130 to base housing 120.

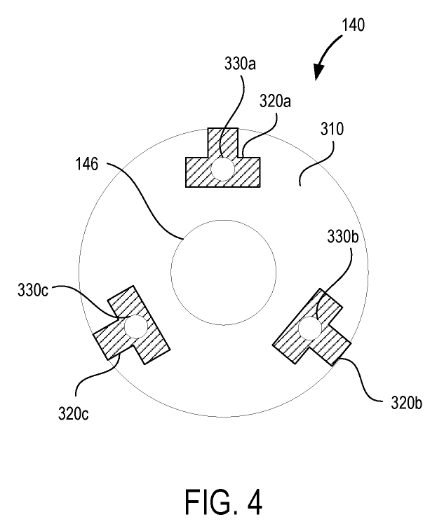

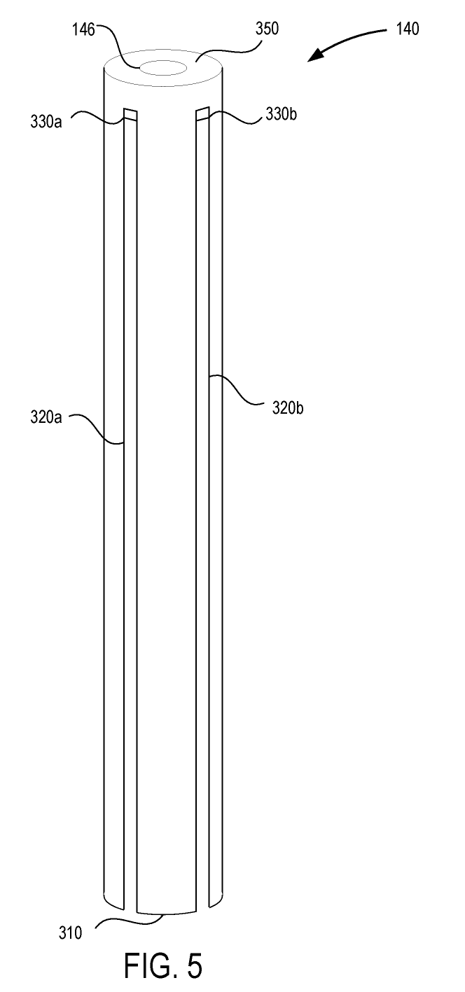

FIG. 4 shows a bottom view of common connector 140 in embodiments using a tongue and groove system for attachment and detachment of display housing 110, base housing 120, keyboard housing 130, according to some embodiments. As shown in FIG. 4, common connector 140 may have 3 grooves (320a, 320b, and 320b) for accepting tongues of display housing 110, base housing 120, and keyboard housing 130. In addition, at the top each of the three grooves 320, common connector 140 can include contacts 330 (330a, 330b, 330c). FIG. 5 shows a side view of common connector 140 in embodiments using a tongue and groove system for attachment and detachment of display housing 110, base housing 120, and keyboard housing 130. As shown in FIG. 5 groove 320 may not extend the full length of common connector 140 in some embodiments to accommodate contacts 330.

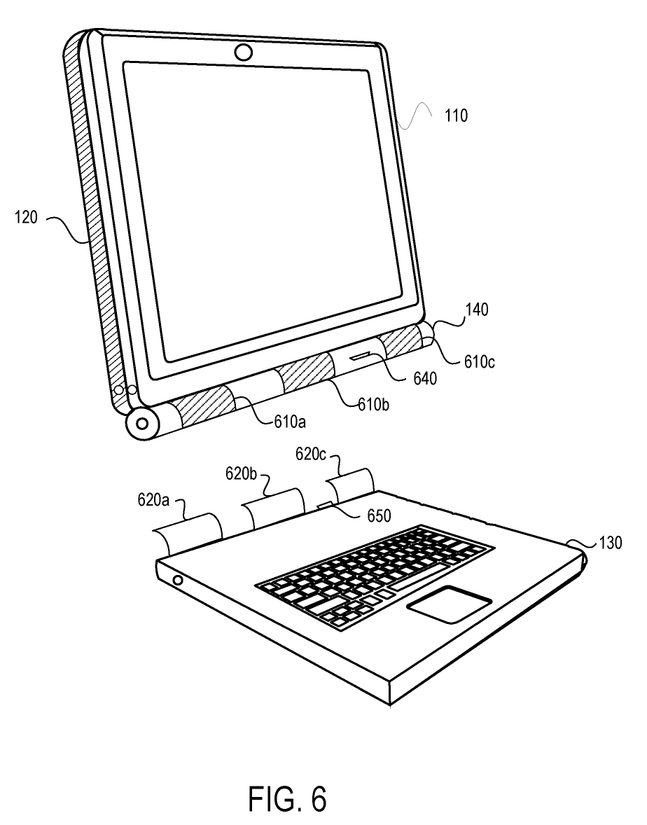

FIG. 6 shows one embodiment of three-part computer device 100 where display housing 110, base housing 120, and keyboard housing 130 attach to common connector 140 using a hook system. Although FIG. 6 shows a hook system with respect to keyboard housing 130, in some embodiments, display housing 110 and base housing 120 may also connect to common connector 140 using a hook system. In embodiments using a hook system, keyboard housing 130 may include one or more hooks 620 that engage with latches 610 on common connector 140. In some embodiments hooks 620 and latches 610 may include magnetic material of opposite polarity to create a secure fit between hook 620 and latches 610. In some embodiments latches 610 and hook 620 may engage using a pressure fit. According to some embodiments, common connector may include contacts 640 which can be a jack or plug connected to conductive material (such as a wire) disposed within a cavity of common connector 140. Likewise, keyboard housing 130 may include contacts 650 which can be a plug or Jack that engages with contact 640 when keyboard housing 130 is attached to common connector 140. When contact 640 engages with contact 650, power and/or data can be transferred between keyboard housing 130 and base housing 120 via a wire in common connector 140, in some embodiments.

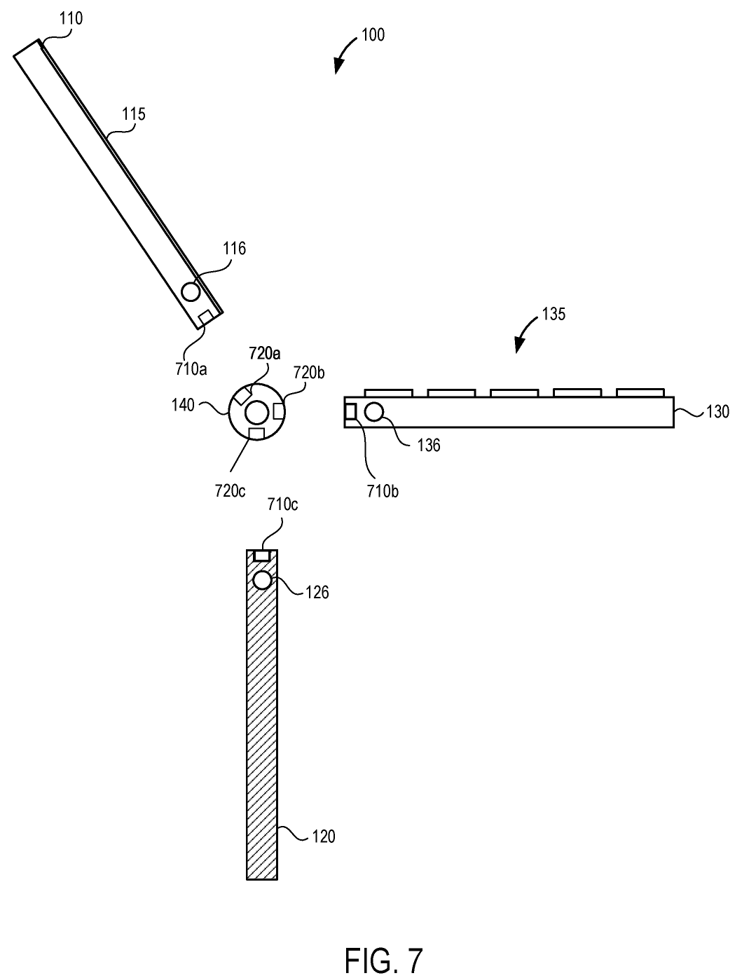

FIG. 7 shows one embodiment of three-part computer device 100 where display housing 110, base housing 120, and keyboard housing 130 attach to common connector 140 using a magnetic system. In such embodiments, display housing 110 may include magnetic attachment member 710a that can engage with magnetic attachment member 720a of common connector 140. Similarly, keyboard housing 130 can include magnetic attachment member 710b that can engage with magnetic attachment for 720b of common connector 140. Likewise, base housing 120 may include magnetic attachment member 710c that can engage with magnetic attachment member 720c of common connector 140. In some embodiments, magnetic attachment members 710 and magnetic attachment members 720 are of opposite polarity and are of sufficient strength to secure display housing 110, base housing 120, and keyboard housing 130 to common connector 140. According to some embodiments, magnetic attachment member 710 and magnetic attachment for 720 can include one or more pins for transferring power and/or data between display housing 110, base housing 120, and keyboard housing 130. In some embodiments, contacts may be disposed on magnetic attachment members 710 and magnetic attachment member 720 so that power and/or data can be exchanged between display housing 110, base housing 120, and keyboard housing 130.

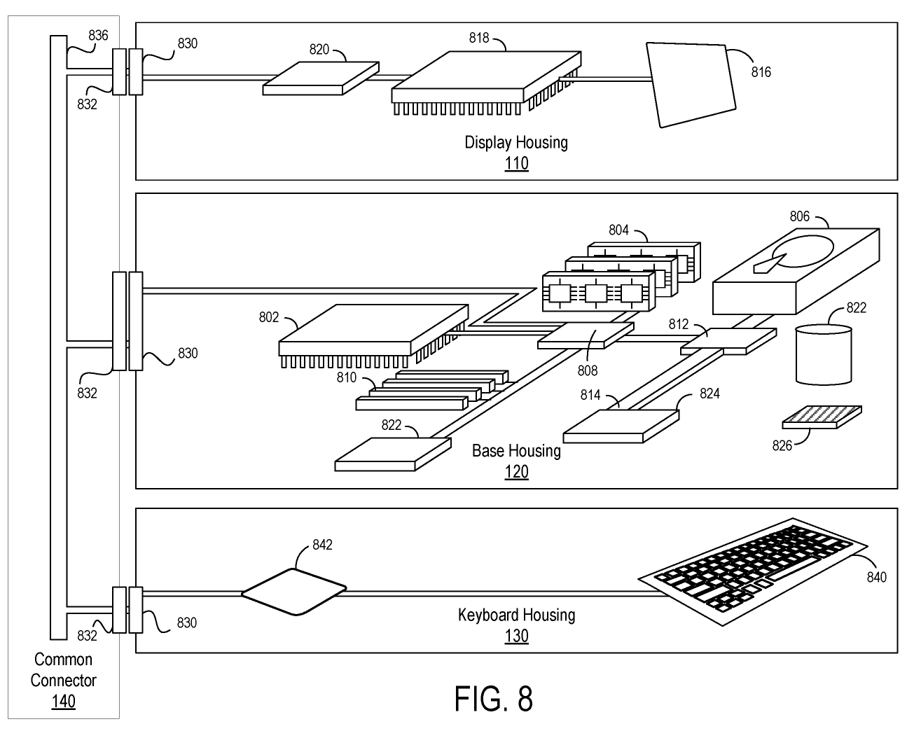

FIG. 8 shows a block diagram of three-part computing device 100 showing the components included in three-part computing device according to one embodiment. The components shown here, their connections and relationships, and their functions, are meant to be exemplary only, and are not meant to limit implementations of the inventions described and/or claimed in this document.

In some embodiments, three-part computing device 100 can include three portions, each contained within a separate housing: display housing 110, base housing 120, and keyboard housing 130. According to some embodiments, base housing 120 can include processor 802, memory 804, storage device 806, high-speed controller 808 connecting to memory 804 and high-speed expansion ports 810, low-speed controller 812 connecting to low-speed bus 814 and storage device 806, external interface 822 connecting to high-speed controller 808, and peripheral ports 824 connecting to low-speed bus 814. Processor 802 can be a semiconductor-based processor. Memory 804 can be a semiconductor-based memory. Each of the components 802, 804, 806, 808, 810, and 812, are interconnected using various busses, and may be mounted on a common motherboard or in other manners as appropriate. Processor 802 can process instructions for execution within the three-part computing device 100, including instructions stored in memory 804 or on storage device 806 to display graphical information for a GUI on display 816 of display housing 110. In other implementations, multiple processors and/or multiple buses may be used, as appropriate, along with multiple memories and types of memory.

Memory 804 stores information within three-part computing device 100. In one implementation, memory 804 is a volatile memory unit or units. In another implementation, memory 804 is a non-volatile memory unit or units. Memory 804 may also be another form of computer-readable medium, such as a magnetic or optical disk. Memory 804 may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 804, expansion memory, or memory on processor 802, that may be received, for example, over external interface 822.

In some embodiments, expansion memory may also be provided and connected to three-part computing device 100 through one or high-speed expansion ports 810. The expansion memory may include, for example, a SIMM (Single In Line Memory Module) card interface. Such expansion memory may provide extra storage space for three-part computing device 100, or may also store applications or other information for three-part computing device 100. Specifically, expansion memory may include instructions to carry out or supplement the processes described above, and may include secure information also. Thus, for example, expansion memory may be provide as a security module for three-part computing device 100, and may be programmed with instructions that permit secure use of three-part computing device 100. In addition, secure applications may be provided via the SIMM cards, along with additional information, such as placing identifying information on the SIMM card in a non-hackable manner.

Storage device 806 is capable of providing mass storage for three-part computing device 100. In one implementation, storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as memory 804, storage device 806, or memory on processor 802.

High-speed controller 808 manages bandwidth-intensive operations for three-part computing device 100, while low-speed controller 812 manages lower bandwidth-intensive operations. Such allocation of functions is exemplary only. In one implementation, high-speed controller 808 is coupled to memory 804, display 816 (e.g., through graphics processor 818 which may include a graphics accelerator), external interface 822, and high-speed expansion ports 810, which may accept various expansion cards (not shown). In the implementation, low-speed controller 812 is coupled to storage device 806 and low-speed expansion port 814. Low-speed expansion port 814 can be connected to peripheral ports 824 which may include various communication ports (e.g., USB, Bluetooth, Ethernet, wireless Ethernet) that may be coupled to one or more input/output devices, such as a keyboard, a pointing device, a scanner, or a networking device such as a switch or router, e.g., through a network adapter. According to some embodiments, display 816 can include a touchscreen. For example, display 816 can include a capacitive touchscreen, a resistive touchscreen, or any other display device that is capable of detecting when an object comes in contact with it. In some embodiments, display 815 can include, for example, a TFT LCD (Thin-Film-Transistor Liquid Crystal Display) or an OLED (Organic Light Emitting Diode) display, or other appropriate display technology.

In some embodiments, processor 802 may communicate with a user through display and control interface 820 coupled to a display 816. The display and control interface 820 may comprise appropriate circuitry for driving the display 816 to present graphical and other information to a user. In some embodiments, display and control interface 820 may receive commands from a user and convert them for submission to the processor 802.

In some embodiments, base housing 120 can include external interface 822 which may be provide in communication with processor 802, so as to enable near area communication of three-part computing device 100 with other devices. External interface 822 may provide, for example, for wired communication in some implementations, or for wireless communication in other implementations, and multiple interfaces may also be used.

In some embodiments, base housing 120 can include one or more power sources such as battery 822 and/or power supply 826. Battery 822 can include any time of battery suitable for powering portable computing devices, such as a lithium-ion battery, for example. Power supply 826 can include, for example, an AC/DC converter or AC adapter that is integrated into base housing 120. In some embodiments, power supply 826 may be external to base housing 120, and may connect to base housing 120 using a power supply port (not shown).

Three-part computing device 100 may communicate audibly using an audio codec, which may receive spoken information from a user and convert it to usable digital information. The audio codec may likewise generate audible sound for a user, such as through a speaker. Such sound may include sound from voice telephone calls, may include recorded sound (e.g., voice messages, music files, etc.) and may also include sound generated by applications operating on three-part computing device 100.

Keyboard housing 130 may include, in some embodiments, keyboard 840 and trackpad 842. Keyboard 840 can include any plurality of keys that can be used to receive input from a user, such as alphanumeric keys or function keys. Trackpad 842 may be a touch-sensitive surface that can detect touch and pressure applied on it and communicate corresponding electric signals representing the direction and magnitude of a touch action, or the magnitude of pressure placed on it.

According to some embodiments, display housing 110, base housing 120, and keyboard housing 130 include portion contacts 830. Portion contacts 830 are capable of interfacing with common connector contacts 832 of common connector 140, to transfer data to and from base housing 120 to and from each of display housing 110 and keyboard housing 130. Portion contacts 830 and common connector contacts 832 can include proprietary contacts designed specifically for use with three-part computer system. In some embodiments, portion contacts 830 and common connector contacts 832 can include known connections such as USB connectors (e.g., mini-type connections, micro type connections). In some embodiments, portion contacts 830 can be jacks or male connectors and common connector contacts 832 can be plugs or female connectors. In some embodiments, portion contacts 830 can be plugs or female connectors and common connector contacts 832 can be jacks or male connectors

In some embodiments, common connector 140 can include conductive material, such as wire 836. In some embodiments, wire 836 can be capable of transferring power and data in some embodiments. In some embodiments, wire 836 may comprise multiple-separate wires—some for transferring power and others for transferring data. The depiction of wire 836 as a singular conductive material is for explanation and exemplary purposes only, and is not intended to limit the scope of the disclosed embodiments. Wire 836 may be connected to common connector contacts 832 and transfer data and/or power to them. Common connector contacts 832, in turn, can transfer the power and data to portion contacts 830 for use by display housing 110 or keyboard housing 130.

FIG. 9 shows a flowchart that illustrates an example process 900 for providing a three-part computing device. According to this example, the process 900 includes providing a display housing comprising a touchscreen (step 910), providing a base housing comprising a processor, a memory, and a battery disposed within the base housing (step 920), and providing a keyboard housing (step 930). Process 900 also includes detachably connecting the display housing, the base housing, and the keyboard housing to a common connector such that the display housing, the base housing, and the keyboard housing are rotatable about a longitudinal axis of the common connector (step 940). The keyboard housing may be detachably coupled to the common connector such that the keyboard housing is detachable from the common connector while the display housing and the base housing remain coupled to the common connector

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It is to be understood that the above description is intended to be illustrative and not restrictive. Many other implementations will be apparent to those of skill in the art upon reading and understanding the above description. The scope of the disclosure should, therefore, be determined with reference to the aspects enumerated below, along with the full scope of equivalents to which such aspects are entitled.

1. A portable computing device comprising:
a display portion including a touchscreen;
a base portion including a central processing unit, a memory, and a battery;
a keyboard portion including a keyboard having a plurality of keys; and
a common connector mechanically coupled to the display portion, the base portion, and the keyboard portion,
wherein the display portion is pivotably rotatable only about a longitudinal axis within the common connector with respect to the base portion and the keyboard portion, and wherein each of the base portion and the keyboard portion is pivotably rotatable only about the longitudinal axis,
wherein the keyboard portion is detachably coupled to the common connector, such that the keyboard portion is detachable from the common connector while the display portion and the base portion remain coupled to the common connector, and
wherein the common connector facilitates a laptop configuration where the portable computing device rests on the base portion, the keyboard portion is positioned for use of the keyboard, and the display portion is positioned for use of the touchscreen.

2. The portable computing device of claim 1, wherein the display portion is pivotably rotatable through more than 180 degrees about the longitudinal axis of the common connector with respect to the base portion or the keyboard portion.

3. The portable computing device of claim 1 wherein the keyboard portion is pivotably rotatable through more than 180 degrees about the longitudinal axis of the common connector with respect to the base portion or the display portion.

4. The portable computing device of claim 1 wherein the base portion is pivotably rotatable through more than 180 degrees about the longitudinal axis of the common connector with respect to the keyboard portion or the display portion.

5. The portable computing device of claim 1 wherein the common connector comprises a hinge.

6. The portable computing device of claim 1 wherein the display portion comprises a first barrel hinge, the base portion comprises a second barrel hinge, the keyboard portion comprises a third barrel hinge, and the common connector comprises a fourth barrel hinge.

7. The portable computing device of claim 1 wherein the common connector includes a cavity through which a wire passes power from the base portion to the display portion.

8. The portable computing device of claim 1 wherein the base portion includes a power supply.

9. A computing device comprising:
a first housing including a touchscreen display;
a second housing including a processor, a memory, and a battery;
a third housing including a keyboard disposed on a face of the third housing; and,
a common connector mechanically connecting the first housing, the second housing, and the third housing such that the first housing, the second housing and the third housing is each rotatable only about a longitudinal axis within the common connector,
wherein the third housing mechanically connects to the common connector at a long edge of the third housing, and the third housing is detachably coupled to the common connector, such that the third housing is detachable from the common connector while the first housing and the second housing remain coupled to the common connector, and
wherein the common connector facilitates a laptop configuration where the computing device rests on the second housing, the third housing is positioned for use of the keyboard, and the first housing is positioned for use of the touchscreen display.

10. The computing device of claim 9 wherein the first housing, the second housing, and the third housing are separate housings.

11. The computing device of claim 9 wherein the first housing is pivotably rotatable through more than 180 degrees about the longitudinal axis of the common connector with respect to the second housing or the third housing.

12. The computing device of claim 9 wherein the second housing is pivotably rotatable through more than 180 degrees about the longitudinal axis of the common connector with respect to the first housing or the third housing.

13. The computing device of claim 9 wherein the third housing is pivotably rotatable through more than 180 degrees about the longitudinal axis of the common connector with respect to the first housing or the second housing.

14. The computing device of claim 9 wherein the common connector comprises a hinge.

15. The computing device of claim 9 wherein the first housing comprises a first barrel hinge, the second housing comprises a second barrel hinge, the third housing comprises a third barrel hinge, and the common connector comprises a fourth barrel hinge.

16. The computing device of claim 9 wherein a face of the first housing is capable of touching a face of the second housing by rotating either the first housing or the second housing about the longitudinal axis of the common connector.

17. The computing device of claim 9 wherein the common connector includes a cavity through which a wire passes power from the second housing to the first housing.

18. A method for providing a computing device, the method comprising:
providing a display housing comprising a touchscreen;
providing a base housing comprising a processor, a memory, and a battery disposed within the base housing;
providing a keyboard housing including a keyboard; and
detachably connecting the display housing, the base housing, and the keyboard housing to a common connector such that the display housing, the base housing, and the keyboard housing is each rotatable only about a longitudinal axis within the common connector,
wherein the keyboard housing is detachably coupled to the common connector such that the keyboard housing is detachable from the common connector while the display housing and the base housing remain coupled to the common connector, and
wherein the common connector facilitates a laptop configuration where the computing device rests on the base housing, the keyboard housing is positioned for use of the keyboard, and the display housing is positioned for use of the touchscreen.

19. The method of claim 18 wherein the display housing comprises a first barrel hinge, the base housing comprises a second barrel hinge, and the keyboard housing comprises a third barrel hinge, and the common connector comprises a fourth barrel hinge.

20. The method of claim 18 wherein the common connector includes a cavity through which a wire passes power from the base housing to the display housing.
